(19) United States
(12) Patent Application Publication
(10) Pub. No.: US 2018/0048952 A1
(43) Pub. Date: Feb. 15, 2018

(54) Neckband-Type Wireless Sound Transducer

(71) Applicant: EM-TECH. Co., Ltd., Busan (KR)

(72) Inventors: Choong Sheek Hong, Gyeonggi-do (KR); Joong Hak Kwon, Gyeongsangnam-do (KR)

(21) Appl. No.: 15/671,537

(22) Filed: Aug. 8, 2017

(30) Foreign Application Priority Data
Aug. 9, 2016 (KR) 1020160101468

(51) Int. Cl. H04R 1/10; G10K 11/175; H04R 1/02

(52) U.S. Cl. CPC H04R 1/10; H04R 1/02; G10K 11/175

(57) ABSTRACT

The present invention relates to a neckband-type wireless sound transducer, and more particularly, to a neckband-type wireless sound transducer that prevents sound from being transferred to the surroundings of the wearer. The neckband-type wireless sound transducer according to the present invention, includes: a main body part configured to be seated on a human body; a main speaker part mounted on the main body part and configured to emit sound to the inside of the main body part; an auxiliary speaker part mounted on the main body part and configured to emit sound for leakage reduction to offset the sound emitted by the main speaker part and leaked to the outside of the main body part; and a controller configured to apply an electric signal for sound emission to the main speaker part and an electric signal for leakage reduction to the auxiliary speaker part.

### PRIORITY CLAIM

The present application claims priority to Korean Patent Application No, 10-2016-0101468 filed on 9 Aug. 2016, the content of said application incorporated herein by reference in its entirety.

### TECHNICAL FIELD

The present invention relates to a neckband-type wireless sound transducer, and more particularly, to a neckband-type wireless sound transducer that prevents sound from being transferred to the surroundings of the wearer.

### BACKGROUND

As a multimedia such as a broadcasting phone ora PMP phone has been built in a smartphone as a main function, the user can enjoy various contents through their smartphone. The demand for a wireless headset has also been increasing with these trends.

Among the wireless communication techniques, Bluetooth, which is a standard for wireless communication between wireless communication devices at a short distance with low power, serves to process data transmission between devices such as a computer, a smartphone, a headset, a personal digital assistant (PDA), a personal computer (PC), and a printer. Bluetooth is a communication technology that can transmit and receive data wirelessly, usually between 10 meters and maximally several hundred meters. A neckband-type speaker for reproducing sound, with being worn around the wearer's neck, without a separate communication cable, has been developed using such a technology and sold on the market.

In addition, the sound generated by the conventional neckband-type speaker is transmitted not only to the wearer but also to the surroundings of the wearer, which disturbs the wearer listening to the sound and unwantedly transfers the sound to the people around the wearer.

### SUMMARY

An object of the present invention is to provide a neckband-type wireless sound transducer that prevents sound from being transferred to the surroundings of the wearer or in an outward direction from the sound transducer.

According to an aspect of the present invention, there is provided a neckband-type wireless sound transducer, including: a main body part which is seated on a human body; a main speaker part which is mounted on the main body part and emits sound to the inside of the main body part; an auxiliary speaker part which is mounted on the main body part and emits sound for leakage reduction to offset the sound emitted by the main speaker part and leaked to the outside of the main body part; and a controller which applies an electric signal for sound emission to the main speaker part and an electric signal for leakage reduction to the auxiliary speaker part.

In some embodiments, at least one speaker included in the main speaker part and at least one speaker for reduction included in the auxiliary speaker part are preferably symmetrical with respect to the center of the main body part.

In some embodiments, the speaker for reduction preferably emits sound for leakage reduction toward the outside of the main body part.

In some embodiments, the controller preferably applies the electric signal for leakage reduction to the speaker for reduction after a delay time proportional to an interval between the speaker of the main speaker part and the speaker for reduction.

In some embodiments, the delay time is preferably calculated as (the interval)/(sound speed).

In some embodiments, the electric signal applied to the speaker of the main speaker part and the electric signal for leakage reduction are preferably opposite in phase to each other.

In some embodiments, at least one speaker included in the main speaker part is preferably provided in a groove formed in the main body part.

In some embodiments, the groove formed in the main body part is preferably inclined in a direction toward the center of the main body part.

According to the present invention, there are the effects of improving the directivity to the wearer's auditory organ and preventing sound from being transferred to the surroundings of the wearer or in an outward direction from the sound transducer, thus ensuring only the wearer to appreciate the sound and preventing the sound from being unwantedly transferred to the people around the wearer.

Those skilled in the art will recognize additional features and advantages upon reading the following detailed description, and upon viewing the accompanying drawings.

### BRIEF DESCRIPTION OF THE DRAWINGS

FIG. 1 is a block diagram of a neckband-type wireless sound transducer according to the present invention.

FIGS. 2a and 2b are a top view and a perspective view of the neckband-type wireless sound transducer of FIG. 1.

FIG, 3 is an explanatory view of a leakage reduction principle of the neckband-type wireless sound transducer of FIG, 1.

### DETAILED DESCRIPTION

Hereinafter, a preferred embodiment of a neckband-type wireless sound transducer according to the present invention will be described in detail with reference to the accompanying drawings.

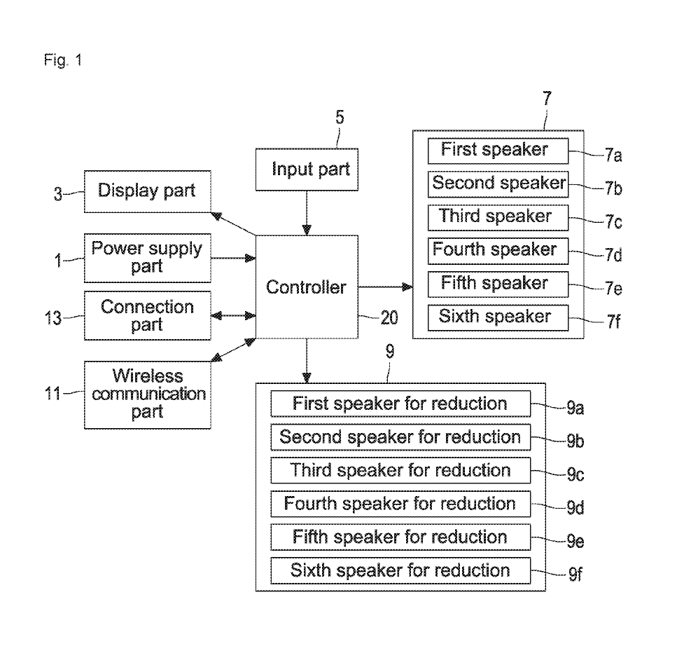

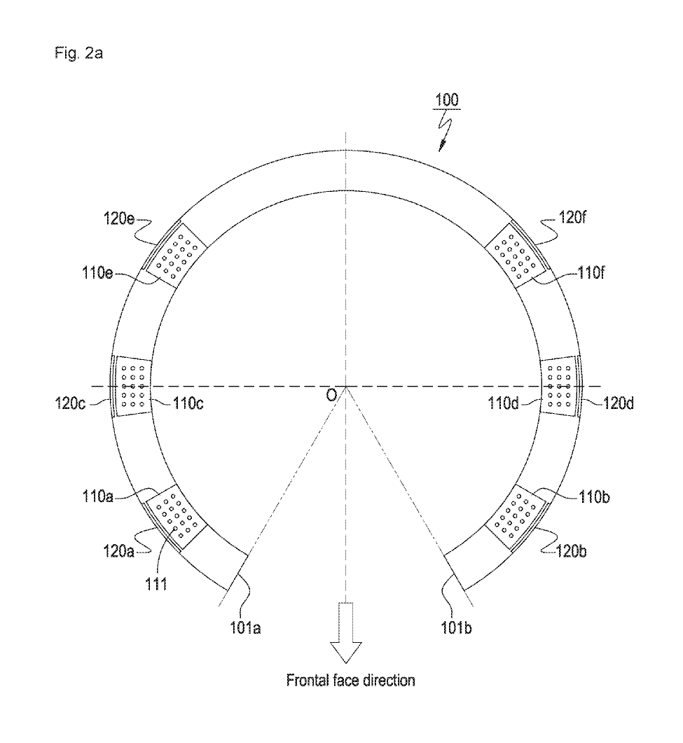

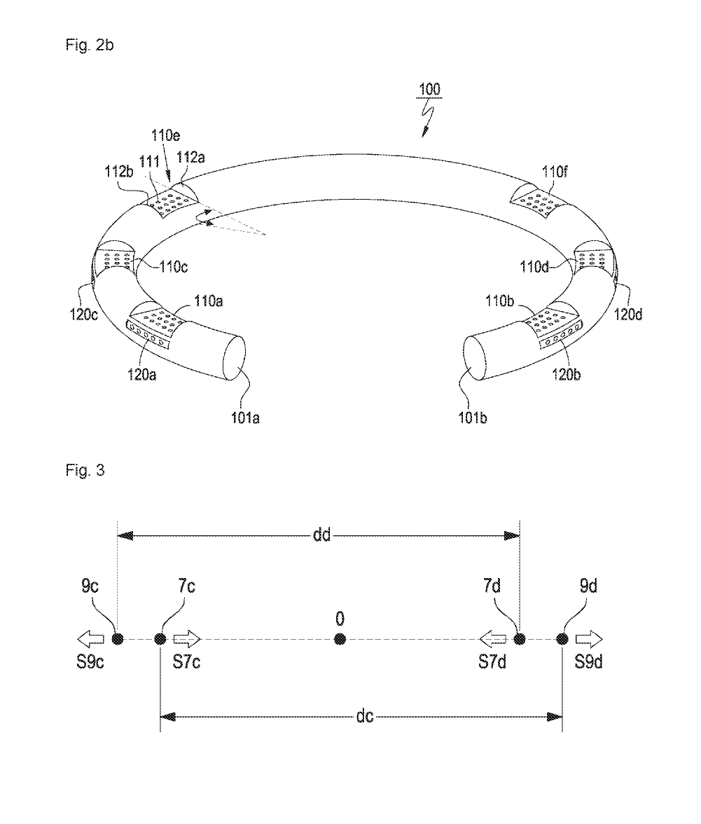

FIG. 1 is a block diagram of a neckband-type wireless sound transducer according to the present invention, and FIGS. 2a and 2b are a top view and a perspective view, respectively, of the neckband-type wireless sound transducer of FIG, 1.

The neckband-type wireless sound transducer includes a power supply part 1 which supplies power, a display part 3 which displays information (operation state, charging state, volume level, played music information, etc.) to the user, an input part 5 which acquires an input (operation control/stop control, volume level adjustment control, played music selection, etc.) from the user, a main speaker part 7 which is mounted on a main body part 100, disposed toward the wearer's auditory organ, and composed of first to sixth speakers 7a to 7f, an auxiliary speaker part 9 which is mounted on the main body part 100 and composed of first to sixth speakers 9a to 9f for reduction that serve to reduce the sound generated by the main speaker part 7 and leaked(or emitted) to the outside of the main body part, a wireless communication part 11 which performs wireless communication (e.g., Bluetooth communication, Wi-Fi communication, etc.) with an external electric communication device, a connection part 13 which is connected to the external electric communication device by wire, and a controller 20 that receives power from the power supply part 1, receives sound data through the wireless communication part 11 according to the input from the input part 5, and plays and emits sound through the main speaker part 7, or receives sound data from the connection part 13 and plays and emits sound through the main speaker part 7, the controller 20 generating and emitting sound for leakage reduction through the auxiliary speaker part 9 so as to reduce sound leakage to the outside of the main body part (i.e., to the surroundings of the wearer) and displaying information such as operation state through the display part 3, when emitting the sound through the main speaker part 7. Here, it is noted that the power supply part 1, the display part 3, the input part 5, the wireless communication part 11 and the connection part 13 are easily recognized by those skilled in the art, so the detailed description thereof is omitted.

In addition, the neckband-type wireless sound transducer according to the present invention includes an annular main body part 100 having a first end 101a and a second end 101b, an opening being formed between the first end 101a and the second end 101b of the main body part 100. The main body part 100 is provided with first to sixth sound-emitting grooves 110a to 110f (collectively referred to as ‘110’), each having a plurality of sound-emitting holes 111, the sound-emitting grooves 110 being formed in the main body part 100 in a stepped or concave manner with respect to the surface of the main body part 100, groove ends 112a and 112b facing each other being formed on both sides of the sound-emitting grooves 110 to allow the sound generated by the first to sixth speakers 7a to 7f to be emitted in a straightforward manner to the wearer's auditory organ. Alternatively, it is also possible to provide a dish-shaped structure that surrounds the entire peripheries of the sound-emitting grooves 110 and is opened toward the upper space of the center O (or toward the wearer's auditory organ) to improve the straightforward emission of the sound.

The first to sixth speakers 7a to 7f are mounted in the sound-emitting grooves 110a to 110f (in the main body part 100), respectively, and the sound (or audio) from the first to sixth speakers 7a to 7f is transferred to the outside or the wearer's auditory organ through the sound-emitting holes 111. The first and sixth sound-emitting grooves 110a and 110f are symmetrically arranged with respect to the center O of the main body part 100, and also the second and fifth sound-emitting grooves 110b and 110e, and the third and fourth sound-emitting grooves 110c and 110d, are symmetrical with respect to the center O of the main body part 100, respectively. As shown in FIG. 2b, the sound-emitting grooves 110 are inclined in a direction toward the center of the main body part 100 at a certain angle to the horizontal direction, and the inclined sound-emitting grooves 110 allow the sound-emitting holes 111 to be directed toward a higher part than the center O of the main body part 100, for example, toward the wearer's auditory organ.

The lower portion of the main body part 100 is seated on the user's back, shoulders, neck, etc., such that the sound-emitting holes 111 are structurally directed toward the user's auditory organ.

Moreover, the main body part 100 includes first to sixth sound-emitting grooves 120a to 120f for reduction, each having a plurality of sound-emitting holes 111, through which the sound for leakage reduction from the first to sixth speakers 9a to 9f for reduction is emitted. The first to sixth sound-emitting grooves 120a to 120f for reduction are disposed toward the outside of the main body part 100 to emit the sound to the outside of the main body part 100. The first and sixth sound-emitting grooves 120a and 120f for reduction are symmetrically arranged with respect to the center O of the main body part 100, and also the second and fifth sound-emitting grooves 120b and 120e for reduction, and the third and fourth sound-emitting grooves 120c and 120d for reduction, are symmetrical with respect to the center O of the main body part 100, respectively.

Further, the first sound-emitting groove 110a and the sixth sound-emitting groove 120f for reduction are symmetrical with respect to the center O, and also the second sound-emitting groove 110b and the fifth sound-emitting groove 120e for reduction, the third sound-emitting groove 110c and the fourth sound-emitting groove 120d for reduction, the fourth sound-emitting groove 110d and the third sound-emitting groove 120c for reduction, the fifth sound-emitting groove 110e and the second sound-emitting groove 120b for reduction, and the sixth sound-emitting groove 110f and the first sound-emitting groove 120a for reduction are symmetrical with respect to the center O, respectively.

The center (middle) of the opening corresponds to the middle between the first end 101a and the second end 101b, and the main body part 100 is formed symmetrically with respect to a first extension line connecting the center of the opening and the center O of the main body part 100. The opening is disposed in a frontal face direction of the wearer, as indicated by an arrow of FIG. 2a.

The first to sixth speakers 7a to 7f are mounted in the main body part 100, corresponding to the first to sixth sound-emitting grooves 110a to 110f, respectively, and controlled separately or together by the controller 20. The first to sixth speakers 7a to 7f emit sound in an inward direction of the main body part 100 (toward the center O) so that the sound can reach the wearer's auditory organ positioned on the inside of the main body part 100. Furthermore, for example, for 2.1 channel, the first and second speakers 7a and 7b, and the fifth and sixth speakers 7e and 7f, may be woofer speakers, while the third speaker 7c and the fourth speaker 7d may be right and left speakers, respectively.

The first to sixth speakers 9a to 9f for reduction are mounted in the main body part 100, corresponding to the first to sixth sound-emitting grooves 120a to 120f for reduction, respectively, and controlled separately or together by the controller 20. The first speaker 9a for reduction prevents the sound from the sixth speaker 7f, which is symmetrically positioned thereto with respect to the center O, from being leaked to the outside of the main body part 100, the second speaker 9b for reduction prevents the sound from the fifth speaker 7e, which is symmetrically positioned thereto with respect to the center O, from being leaked to the outside of the main body part 100, the third speaker 9c for reduction prevents the sound from the fourth speaker 7d, which is symmetrically positioned thereto with respect to the center O, from being leaked to the outside of the main body part 100, the fourth speaker 9d for reduction prevents the sound from the third speaker 7c, which is symmetrically positioned thereto with respect to the center O, from being leaked to the outside of the main body part 100, the fifth speaker 9e for reduction prevents the sound from the second speaker 7b, which is symmetrically positioned thereto with respect to the center O, from being leaked to the outside of the main body part 100, and the sixth speaker 9f for reduction prevents the sound from the first speaker 7a, which is symmetrically positioned thereto with respect to the center O, from being leaked to the outside of the main body part 100,

The power supply part 1, the wireless communication part 11 and the controller 20 are mounted on the inside of the main body part 100, while the display part 3, the input part 5 and the connection part 13 are provided on the side surfaces of the main body part 100 to be externally shown.

The controller 20 receives sound data (e.g., MP3, MP4, audio data, etc.) from an electric communication device (e.g., smartphone, MP3 player, etc.) through the wireless communication part 11 and converts it into an electric signal playable by the speaker part 7, using a built-in playing program such as Codec. Upon the conversion into the electric signal, the controller 20 may convert the sound data into an electric signal which is a stereo signal or into an electric signal which is a multi-channel channel signal for multi-channel play (e.g., 2.1 channel, 3.1 channel, 4.1 channel, 5.1 channel, etc.). For the purpose of converting the sound data into the electric signal, the controller 20 receives an input for selection of a sound type (e.g., stereo, multi-channel, etc.) from the input part 5 and controls the built-in playing program according to the input for selection.

The controller 20 generates an electric signal for sound playing and applies the electric signal to the speaker part 7 so that it can play sound. Particularly, in the case of stereo playing or multi-channel playing, the controller 20 applies the same or different electric signals to the first to sixth speakers 7a to 7f or selectively applies the electric signals to the first to sixth speakers 7a to 7f, so that they can play sound.

In addition, in order to prevent the sound emitted by the speaker part 7 from being leaked to the outside of the main body part 100 so that people other than the wearer could hear the sound, the controller 20 controls the sixth to the first speakers 9f to 9a for playing to emit, to the outside of the main body part 100, the sound having the opposite phase to the sound emitted by the first to sixth speakers 7a to 7f. Hereinafter, this process will be described in detail.

FIG. 3 is an explanatory view of a leakage reduction principle of the neckband-type wireless sound transducer of FIG. 1.

The third and fourth speakers 7c and 7d are arranged symmetrically with respect to the center O of the main body part 100, the third speaker 9c for reduction being disposed on the extension line between the fourth speaker 7d and the center O, the fourth speaker 9d for reduction being disposed on the extension line between the third speaker 7c and the center O. The interval between the third speaker 7c and the fourth speaker 9d for reduction is a distance dc, while the interval between the fourth speaker 7d and the third speaker 9c for reduction is a distance dd.

The sound emitted by the third speaker 7c reaches the fourth speaker 9d for reduction after a delay time (dc/c: c is a sound speed). The controller 20 stores the delay time proportional to the distance dc, starts to apply an electric signal to the third speaker 7c, then generates an electric signal for leakage reduction, which is opposite in phase to the electric signal applied to the third speaker 7c, applies the electric signal for leakage reduction to the fourth speaker 9d for reduction after the delay time, and allows the fourth speaker 9d for reduction to emit the sound for leakage reduction to the outside of the main body part 100, such that the sound emitted by the third speaker 7c is offset by the sound for leakage reduction that is emitted by the fourth speaker 9d for reduction, on the outside of the main body part 100, that is, in an outward direction from the fourth speaker 9d for reduction. This sound offsetting operation considerably reduces the volume level of the sound from the third speaker 7c on the outside of the main body part 100.

With the same principle, the sound emitted by the fourth speaker 7d is offset on the outside of the main body part 100 by the sound for leakage reduction that is emitted by the third speaker 9c for reduction. This principle equally applies to the sound of the first and second speakers 7a and 7b and to the sound of the fifth and sixth speakers 7e and 7f.

While this invention has been described in connection with what is presently considered to be practical exemplary embodiments, it is to be understood by those skilled in the art that the invention is not limited to the disclosed embodiments, but on the contrary, is intended to cover various modifications and equivalent arrangements included within the spirit and scope of the appended claims.

What is claimed is:

1. A neckband-type wireless sound transducer, comprising:
a main body part configured to be seated on a human body;
a main speaker part mounted on the main body part and configured to emit sound to the inside of the main body part;
an auxiliary speaker part mounted on the main body part and configured to emit ound for leakage reduction to offset the sound emitted by the main speaker part and leaked to the outside of the main body part; and
a controller configured to apply an electric signal for sound emission to the main speaker part and an electric signal for leakage reduction to the auxiliary speaker part.

2. The neckband-type wireless sound transducer of claim 1, wherein at least one speaker included in the main speaker part and at least one speaker for reduction included in the auxiliary speaker part are symmetrical with respect to the center of the main body part.

3. The neckband-type wireless sound transducer of claim 2, wherein the at least one speaker for reduction is configured to emit sound for leakage reduction toward the outside of the main body part.

4. The neckband-type wireless sound transducer of claim 2, wherein the controller is configured to apply the electric signal for leakage reduction to the at least one speaker for reduction after a delay time proportional to an interval between the least one speaker included in the main speaker part and the at least one speaker for reduction.

5. The neckband-type wireless sound transducer of claim 4, wherein the delay time is calculated as an interval between the at least one speaker included in the main speaker part and the at least one speaker for reduction divided by sound speed.

6. The neckband-type wireless sound transducer of claim 4, wherein the electric signal applied to the at least one speaker of the main speaker part and the electric signal for leakage reduction are opposite in phase to each other.

7. The neckband-type wireless sound transducer of claim 1, wherein at least one speaker included in the main speaker part is provided in a groove formed in the main body part.

8. The neckband-type wireless sound transducer of claim 7, wherein the groove formed in the main body part is inclined in a direction toward the center of the main body part.
